(19) United States
(12) Patent Application Publication
(10) Pub. No.: US 2004/0168980 A1
(43) Pub. Date: Sep. 2, 2004

(54) Combination polymer treatment for flux enhancement in MBR

(76) Inventors: Deepak A. Musale, Aurora, IL (US); Seong-Hoon Yoon, Naperville, IL (US); John H. Collins, Bloomingdale, IL (US)

Correspondence Address: Margaret Brumm, Patent and Licensing Department, Nalco Company, 1601 West Diehl Road, Naperville, IL, 60563-1198, US

(21) Appl. No.: 10/787,989

(22) Filed: Feb. 26, 2004

Related U.S. Application Data
(63) Continuation-in-part of application No. 10/329,791, filed on Dec. 26, 2002.
Application No. 10/329,791 is a continuation-in-part of application No. 10/035,785, filed on Jan. 4, 2002, now Pat. No. 6,723,245.

(51) Int. Cl. C02F 1/44

(52) U.S. Cl. 210/639

(57) ABSTRACT

A method of conditioning mixed liquor in a membrane biological reactor comprising adding one or more water soluble anionic polymers to the mixed liquor and also adding one or more water soluble cationic, amphoteric or zwitterionic polymers, or combination thereof; wherein said one or more water soluble anionic polymers may be added either before, simultaneously with or after the addition of said water soluble cationic, amphoteric or zwitterionic polymers is described and claimed. Also described and claimed are methods of reducing membrane fouling, enhancing membrane flux and reducing sludge production.

### CROSS REFERENCE TO RELATED APPLICATIONS

This patent application is a continuation-in-part of U.S. patent application Ser. No. 10/329,791, filed Dec. 26, 2002, now pending, which is a continuation-in-part of U.S. patent application Ser. No. 10/035,785, filed Jan. 4, 2002, now allowed.

### FIELD OF THE INVENTION

This invention is in the field of membrane biological reactors. Specifically this invention concerns the use of a combination of one or more water soluble anionic polymer and one or more polymers selected from the group of water soluble cationic, amphoteric or zwitterionic polymers; where the combination is used to condition mixed liquor in membrane biological reactors resulting in reduced fouling and increased water flux through the membrane. This invention is also a method of using a combination of these polymers to reduce sludge production in the bioreactor.

### BACKGROUND OF THE INVENTION

Biological treatment of wastewater for removal of dissolved organics is well known and is widely practiced in both municipal and industrial plants. This aerobic biological process is generally known as the “activated sludge” process in which micro-organisms consume the organic compounds through their growth. The process necessarily includes sedimentation of the micro-organisms or “biomass” to separate it from the water and complete the process of reducing Biological Oxygen Demand (BOD) and TSS (Total Suspended Solids) in the final effluent. The sedimentation step is typically done in a clarifier unit. Thus, the biological process is constrained by the need to produce biomass that has good settling properties. These conditions are especially difficult to maintain during intermittent periods of high organic loading and the appearance of contaminants that are toxic to the biomass.

Typically, this activated sludge treatment has a conversion ratio of organic materials to sludge of about 0.5 kg sludge/kg COD (chemical oxygen demand), thereby resulting in the generation of a considerable amount of excess sludge that must be disposed of. The expense for the excess sludge treatment has been estimated at 40-60 percent of the total expense of wastewater treatment plant. Moreover, the conventional disposal method of landfilling may cause secondary pollution problems. Therefore, interest in methods to reduce the volume and mass of the excess sludge has been growing rapidly.

Membranes coupled with biological reactors for the treatment of wastewater are well known, but are not widely practiced. In these systems, ultrafiltration (UF), microfiltration (MF) or nanofiltration (NF) membranes replace sedimentation of biomass for solids-liquid separation. The membrane can be installed in the bioreactor tank or in an adjacent tank where the mixed liquor is continuously pumped from the bioreactor tank and back producing effluent with much lower total suspended solids (TSS), typically less than 5 mg/L, compared to 20 to 50 mg/L from a clarifier. More importantly, MBRs (membrane biological reactors) de-couple the biological process from the need to settle the biomass, since the membrane sieves the biomass from the water. This allows operation of the biological process at conditions that would be untenable in a conventional system including: 1) high MLSS (bacteria loading) of 10-30 g/L, 2) extended sludge retention time, and 3) short hydraulic retention time. In a conventional system, such conditions could lead to sludge bulking and poor settleability.

The benefits of the MBR operation include low sludge production, complete solids removal from the effluent, effluent disinfection, combined COD, solids and nutrient removal in a single unit, high loading rate capability, no problems with sludge bulking, and small footprint. Disadvantages include aeration limitations, membrane fouling, and membrane costs.

Membrane costs are directly related to the membrane area needed for a given volumetric flow through the membrane, or “flux.” Flux is expressed as liters/hour/m² (LMH) or gallons/day/ft² (GFD). Typical flux rates vary from approximately 10 LMH to about 50 LMH. These relatively low flux rates, due largely to fouling of the membranes, have slowed the growth of MBR systems for wastewater treatment.

The MBR membrane interfaces with so-called “mixed liquor” which is composed of water, dissolved solids such as proteins, polysaccharides, suspended solids such as colloidal and particulate material, aggregates of bacteria or “flocs”, free bacteria, protozoa, and various dissolved metabolites and cell components. In operation, the colloidal and particulate solids and dissolved organics deposit on the surface of the membrane. Colloidal particles form layer on the surface of the membrane called a “cake layer.” Cake layer formation is especially problematic in MBRs operated in the “dead end” mode where there is no cross flow; i.e., flow tangential to the membrane. Depending on the porosity of the cake layer, hydraulic resistance increases and flux declines.

In addition to the cake formation on the membrane, small particles can plug the membrane pores, a fouling condition that may not be reversible. Compared to a conventional activated sludge process, floc (particle) size is reportedly much smaller in typical MBR units. Since MBR membrane pore size varies from about 0.04 to about 0.4 micrometers, particles smaller than this can cause pore plugging. Pore plugging increases resistance and decreases flux.

Therefore, there is an ongoing need to develop improved methods of conditioning the mixed liquor in MBR units to increase flux and reduce fouling of the membranes.

### SUMMARY OF THE INVENTION

The first aspect of the instant claimed invention is a method of conditioning mixed liquor in a membrane biological reactor comprising:

adding one or more water soluble anionic polymers to the mixed liquor; and

adding one or more water soluble cationic, amphoteric or zwitterionic polymers, or a combination thereof to the mixed liquor;

wherein said one or more water soluble anionic polymers may be added either before, simultaneously or after the addition of said water soluble cationic, amphoteric or zwitterionic polymers.

The second aspect of the instant claimed invention is a method of clarifying wastewater in a membrane biological reactor where microorganisms consume organic material in the wastewater to form a mixed liquor comprising water, the microorganisms and dissolved and suspended solids comprising:

adding one or more water soluble anionic polymers to the mixed liquor;

adding one or more water soluble cationic, amphoteric or zwitterionic polymers, or a combination thereof to the mixed liquor to form a mixture comprising water, the microorganisms and coagulated and flocculated solids; and

separating clarified water from the microorganisms and the coagulated and flocculated solids by filtration through a membrane; wherein said one or more water soluble anionic polymers may be added either before, simultaneously or after the addition of said water soluble cationic, amphoteric or zwitterionic polymers.

The third aspect of the instant claimed invention is a method of preventing fouling of a filtration membrane in a membrane biological reactor where microorganisms consume organic material in the wastewater in a mixed liquor comprising water, the microorganisms and dissolved, colloidal and suspended solids and wherein clarified water is separated from the mixed liquor by filtration through the filtration membrane comprising

adding one or more water soluble anionic polymers to the mixed liquor; and

adding to the mixed liquor an amount of one or more cationic, amphoteric or zwitterionic polymers, or a combination thereof, sufficient to prevent fouling of the membrane; wherein said one or more water soluble anionic polymers may be added either before, simultaneously or after the addition of said water soluble cationic, amphoteric or zwitterionic polymers.

The fourth aspect of the instant claimed invention is a method of enhancing flux through a filtration membrane in a membrane biological reactor where microorganisms consume organic material in the wastewater in a mixed liquor comprising water, the microorganisms and dissolved, colloidal and suspended solids and wherein clarified water is separated from the mixed liquor by filtration through the filtration membrane comprising

adding one or more water soluble anionic polymers to the mixed liquor; and

adding to the mixed liquor an effective flux enhancing amount of one or more cationic, amphoteric or zwitterionic polymers, or a combination thereof, wherein said one or more water soluble anionic polymers may be added either before, simultaneously or after the addition of said water soluble cationic, amphoteric or zwitterionic polymers.

The fifth aspect of the instant claimed invention is a method of reducing sludge formation in a membrane biological reactor where microorganisms consume organic material in the wastewater to form a mixed liquor comprising water, the microorganisms and a sludge comprising dissolved, colloidal and suspended solids and wherein clarified water is separated from the mixed liquor by filtration through a membrane comprising

adding one or more water soluble anionic polymers to the mixed liquor;

adding to the mixed liquor an effective coagulating and flocculating amount of one or more cationic, amphoteric or zwitterionic polymers, or a combination thereof; and

increasing the concentration of microorganisms in the mixed liquor; wherein said one or more water soluble anionic polymers may be added either before, simultaneously or after the addition of said water soluble cationic, amphoteric or zwitterionic polymers.

The sixth aspect of the instant claimed invention is a method of reducing sludge formation in a membrane biological reactor where microorganisms consume organic material in the wastewater to form a mixed liquor comprising water, the microorganisms and a sludge comprising dissolved, colloidal and suspended solids and wherein clarified water is separated from the mixed liquor by filtration through a membrane comprising

adding one or more water soluble anionic polymers to the mixed liquor;

adding to the mixed liquor an effective coagulating and flocculating amount of one or more cationic, amphoteric or zwitterionic polymers, or a combination thereof; and

increasing the amount of time that the microorganisms remain in contact with the wastewater;

wherein said one or more water soluble anionic polymers may be added either before, simultaneously or after the addition of said water soluble cationic, amphoteric or zwitterionic polymers.

It has been discovered that using one or more water soluble anionic polymers and one or more water soluble cationic, amphoteric and zwitterionic polymers in the MBR to coagulate and flocculate the biomass in the mixed liquor and to precipitate the soluble biopolymer substantially reduces fouling of the membrane and can result in an increase of up to 500 percent in membrane flux while leaving virtually no excess polymer in the treated wastewater at the effective dose. This increase in membrane flux permits the use of smaller systems, with a concomitant reduction in capital costs, or alternatively, increases treated wastewater volumetric flow from an existing system, with a corresponding reduction in cost of operation.

The water soluble anionic polymer may be added either before the water soluble cationic, amphoteric and zwitterionic polymers are added or the water soluble anionic polymer may be added after the water soluble cationic, amphoteric and zwitterionic polymers are added or the water soluble anionic polymer may be added simultaneously with the water soluble cationic, amphoteric and zwitterionic polymers.

### BRIEF DESCRIPTION OF THE DRAWING

FIG. 1 is a schematic diagram of a typical membrane bioreactor system for the biological treatment of wastewater comprising an aeration tank 1, submerged membrane module 2, suction pump 3, aeration means 4 for membrane scouring, aeration means 5 for the bioreaction and optional sludge disintegrator 6.

### DETAILED DESCRIPTION OF THE INVENTION

Throughout this patent application the following terms have the indicated meanings.

AcAm for acrylamide;

BOD: Biological Oxygen Demand (mg L⁻¹ or ppm);

COD: Chemical Oxygen Demand (mg L⁻¹ or ppm);

“Conditioning” means precipitating soluble biopolymer and coagulating and flocculating the particulate and colloidal organic material in the mixed liquor to form larger aggregates of particles, resulting in an increase in flux through the membrane bioreactor filtration membrane and a reduction of fouling of the membrane;

DADMAC for diallyldimethylammonium chloride;

pDADMAC for poly(diallyldimethylammonium chloride);

dalton for a unit of mass equal to 1/12 the mass of ¹²O;

DMAEA.BCQ for dimethylaminoethylacrylate benzyl chloride quaternary salt;

DMAEA.MCQ for dimethylaminoethylacrylate methyl chloride quaternary salt;

Epi-DMA for epichlorohydrin-dimethylamine;

GFD: gallons/ft²/day;

HRT: Hydraulic Retention Time (hours or days) means the time the wastewater stays in the bioreactor. It is obtained by dividing the total volume of the bioreactor by the influent flow rate;

LMH: liters/m²/hr;

MBR: Membrane Bioreactor or Membrane Biological Reactor;

MF: Microfiltration;

“Mixed Liquor” or “sludge” means a mixture of wastewater, microorganisms used to degrade organic materials in the wastewater, organic-containing material derived from cellular species, cellular by-products and/or waste products, or cellular debris. Mixed liquor can also contain colloidal and particulate material (i.e. biomass/biosolids) and/or soluble molecules or biopolymers (i.e. polysaccharides, proteins, etc.);

MLSS: Mixed Liquor Suspended Solid (mg L⁻¹ or ppm) means the concentration of biomass which is treating organic material, in the mixed liquor;

“Monomer” means a polymerizable allylic, vinylic or acrylic compound. The monomer may be anionic, cationic or nonionic. Vinyl monomers are preferred, acrylic monomers are more preferred;

NF: Nanofiltration;

PEI for polyethyleneimine;

“Prevention” includes both preventing and inhibiting;

“Reduced Specific Viscosity” (RSV) is an indication of polymer chain length and average molecular weight. The RSV is measured at a given polymer concentration and temperature and calculated as follows:

$$RSV = \frac{[ ( \frac{η}{{η}_{o}} ) - 1 ]}{c}$$

wherein η=viscosity of polymer solution;

ηₒ=viscosity of solvent at the same temperature; and

c=concentration of polymer in solution.

As used herein, the units of concentration “c” are (grams/100 ml or g/deciliter). Therefore, the units of RSV are dl/g. The RSV is measured at 30° C. The viscosities η and ηₒ are measured using a Cannon-Ubbelohde semimicro dilution viscometer, size 75. The viscometer is mounted in a perfectly vertical position in a constant temperature bath adjusted to 30±0.02° C. The error inherent in the calculation of RSV is about 2 dl/g. Similar RSVs measured for two linear polymers of identical or very similar composition is one indication that the polymers have similar molecular weights, provided that the polymer samples are treated identically and that the RSVs are measured under identical conditions;

IV stands for intrinsic viscosity, which is RSV in the limit of infinite polymer dilution (i.e. the polymer concentration is equal to zero). The IV, as used herein, is obtained from the y-intercept of the plot of RSV versus polymer concentration in the range of 0.015-0.045 wt % polymer;

SRT: Sludge Retention Time (days) means the amount of time that microorganisms, which roughly approximates sludge, remain inside the bioreactor. SRT is calculated by dividing the total sludge in the bioreactor by the sludge removal rate. The residence time for the microorganisms in the reactor is also known as “sludge age”;

TMP: Trans-Membrane Pressure;

TSS: Total Suspended Solid (mg L⁻¹ or ppm); and

UF: Ultrafiltration.

In a biological wastewater treatment process, microorganisms in the bioreactor grow with the consumption of organic substrate contained in wastewater. In addition, the microorganisms respire endogenously, consuming themselves. These phenomena are described by Eq (1), where microbial growth is expressed by the Monod equation minus endogenous respiration represented by the first order kinetic equation (k_{d}x) on the far the right side of the equation.

$$\frac{ⅆ x}{ⅆ t} = \frac{{μ}_{m} {S}_{e}}{{K}_{s} + {S}_{e}} x - {k}_{d} x \qquad ( 1 )$$

Here, μₘ is the maximum specific growth rate (day⁻¹), Kₛ is the half saturation constant (mg L⁻¹), k_{d} is the endogenous decay constant (day⁻¹), Sₑ is the substrate concentration in mixed liquor (mg L⁻¹), x is the MLSS (mg L⁻¹) and t is the time (days).

While microorganisms are growing, the majority of the substrate (organic pollutants in the influent) is consumed and some goes out with effluent. This balance can be described as Eq (2) where the first term on the right side expresses the organic mass balance between influent and effluent and the second term substrate consumption by microorganisms.

$$\frac{ⅆ {S}_{e}}{ⅆ t} = \frac{Q}{V} ( {S}_{i} - {S}_{e} ) - \frac{1}{Y} \frac{{μ}_{m} {S}_{e}}{{K}_{s} + {S}_{e}} x \qquad ( 2 )$$

Where Q is the influent flow rate (m³ day⁻¹) and Y is the yield coefficient (kg MLSS kg COD⁻¹), V is the reactor volume (m³) and Sᵢ is the influent COD (mg L⁻¹). All constants and parameters used in the foregoing calculations are summarized in Table 1.

TABLE 1
Values of kinetic and stoichiometric
parameters used in calculation

| Parameter | Unit | Value | Source |
|---|---|---|---|
| k_{d1} | Day⁻¹ | 0.028 | Water Science and |
| | | | Technology, 38 |
| | | | (4-5), 497-504, 1998 |
| K_{s2,3} | .mg L⁻¹ | 100 | Water Research |
| | | | 21(5), 505-515, |
| | | | 1987, Biological |
| | | | Wastewater |
| | | | Treatment, pp 61-125, (1999) |
| Y₃ | kg MLSS kg COD⁻¹ | 0.5 | Biological |
| | | | Wastewater |
| | | | Treatment, pp |
| | | | 61-125, (1999) |
| β₃ | kg COD kg MLSS⁻¹ | 1.2 | |
| μ_{m2,3} | day⁻¹ | 3 | Water Research |
| | | | 21(5), 505-515, |
| | | | 1987, Biological |
| | | | Wastewater |
| | | | Treatment, pp 61-125, |
| | | | (1999) |

The above two equations provide the theoretical analysis useful in analyzing the results of the instant claimed invention.

The first aspect of the instant claimed invention is a method of conditioning mixed liquor in a membrane biological reactor comprising:

adding one or more water soluble anionic polymers to the mixed liquor; and

adding one or more water soluble cationic, amphoteric or zwitterionic polymers, or a combination thereof to the mixed liquor;

wherein said one or more water soluble anionic polymers may be added either before, simultaneously or after the addition of said water soluble cationic, amphoteric or zwitterionic polymers.

The MBR unit combines two basic processes, biological degradation and membrane separation, into a single process where suspended solids and microorganisms responsible for biodegradation are separated from the treated water by a membrane filtration unit. See Water Treatment Membrane Processes, McGraw-Hill, 1996, p 17.2. The entire biomass is confined within the system, providing for both control of the residence time for the microorganisms in the reactor and the disinfection of the effluent.

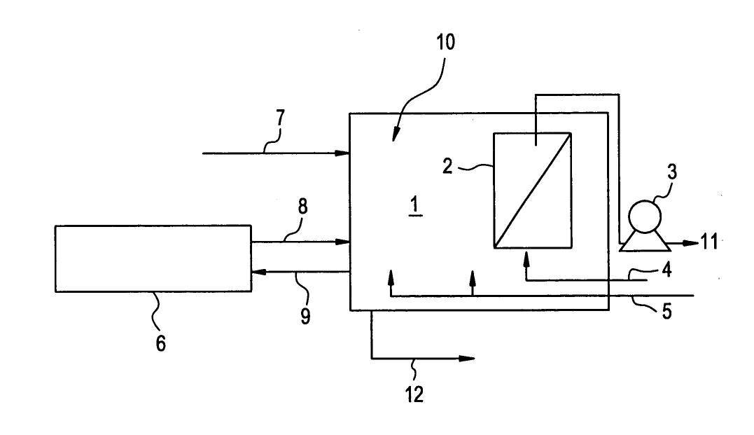

In a typical MBR unit, as shown in FIG. 1, for the biological treatment of wastewater there is an aeration tank 1, submerged membrane module 2, suction pump 3, aeration means 4 for membrane scouring, aeration means 5 for the bioreaction and optional sludge disintegrator 6. Influent wastewater 7 is pumped or gravity flowed into the aeration tank 1 where it is brought into contact with the biomass, which biodegrades organic material in the wastewater. Aeration means 5 provide oxygen to the biomass. Aeration means 5 can be any commercially available equipment capable of providing oxygen to the biomass, such as blowers.

The resulting mixed liquor is pumped from aeration tank 1 into the membrane module 2 where it is filtered through a membrane under pressure or is drawn through a membrane under low vacuum. In FIG. 1, membrane module 2 is located inside aeration tank 1; another configuration of this equipment is possible (not shown) where membrane module 2 is located outside aeration tank 1.

The effluent 11 is discharged from the system while the concentrated mixed liquor is returned to the bioreactor. Excess sludge 9 is pumped out in order to maintain a constant sludge age, and the membrane is regularly cleaned by backwashing, chemical washing, or both.

The polymers used in the instant claimed invention enter the aeration tank 1 through line 10 or through sludge disintegrator return line 8.

Membranes used in the MBR unit include ultra-, micro- and nanofiltration, inner and outer skin, hollow fiber, tubular, and flat, organic, metallic, ceramic, and the like. Preferred membranes for commercial application include hollow fiber with an outer skin ultrafilter, flat sheet (in stacks) microfilter and hollow fiber with an outer skin microfilter. Preferred membrane materials include chlorinated polyethylene (PVC), polyvinylidene fluoride (PVDF), polyacrylonitrile (PAN), polysulfone (PSF), polyethersulfone (PES), polyvinylalcohol (PVA), cellulose acetate (CA), regenerated cellulose (RC) as well as inorganics.

Additional sludge disintegration devices 6 can be attached to the MBR to enhance sludge decay. Excess sludge 9 from the aeration tank 1 is pumped into the disintegration device for further degradation. The liquified sludge 8 exiting the disintegration devices is recycled to bioreactor again. The polymers used in the instant claimed invention may also be added through sludge disintegrator return line 8.

Examples of sludge disintegration devices include ozonation, alkaline treatment, heat treatment, ultrasound, and the like. In this case protoplasmic materials contained in the disintegrated sludge will contribute to increased biopolymer (i.e. proteins, polysaccharides) levels in the mixed liquor. This additional biopolymer is removed by the combination polymer treatment described and claimed herein.

The wastewater may be pretreated before entering the MBR. For example, a bar screen, grit chamber or rotary drum screen may be used to achieve coarse solids removal. In industrial plants where synthetic oils are present in the untreated wastewater, such as an oil refinery, pretreatment to remove oil is accomplished in units such as the inclined plate separator and the induced air flotation unit (IAF). Often, a cationic flocculent, such as a co-polymer of DMAEM and AcAm, is used in the IAF unit to increase oil removal. Also, excess phosphate is sometimes precipitated in the bioreactor by the addition of metal salts such as ferric chloride, so that the phosphate does not pass through the membrane and into the final effluent.

Depending on the ultimate use of the water and the purity of the MBR permeate, the clarified wastewater may also be subjected to post treatment. For instance, in water reclamation where treated wastewater is ultimately recharged into an aquifer used as a source for drinking water, the permeate may be further treated with reverse osmosis (RO) to reduce the dissolved mineral content. If the water is to be recycled into a process, then the requirements of that process may necessitate further treatment of the permeate for removal of recalcitrant organics not removed by the MBR. Processes such as nanofiltration or carbon adsorption might be used in these cases. Finally, all biologically treated wastewater may be further disinfected prior to discharge into a receiving stream, generally by addition of sodium hypochlorite, although this is not required for discharge into a municipal sewer.

As discussed above, in the MBR process complete retention of the biomass by the membrane process makes it possible to maintain high MLSS in bioreactor, and this high MLSS allows for a longer solid retention time (SRT). Consequently, the MBR sludge production rate, which is inversely proportional to the SRT, is much reduced compared to the conventional activated sludge process, to about 0.3 kg sludge/kg COD. However, the expense for sludge treatment in the MBR plant is still estimated to be 30˜40% of the total expense.

As discussed above, sludge production can be much reduced simply by increasing HRT or target MLSS of bioreactor. However, this method will accelerate membrane fouling and may finally increase ‘membrane cleaning frequency’.

In fact high HRT and high MLSS cause high SRT. Under these conditions, microorganisms remain in the bioreactor for an extended period, during which time some old microorganisms decay automatically. During this decay process, substantial amounts of miscellaneous protoplasmic materials such as polysaccharides, proteins etc are produced. These materials are commonly referred to as ‘biopolymer’. This biopolymer will be added to the background biopolymer, so called extra-cellular polymer (ECP) secreted by microorganisms. Consequently high SRT causes a high level of biopolymer which is a major membrane foulant.

Therefore, sludge reduction by increasing HRT and/or MLSS is limited by accelerated membrane fouling by biopolymer. The high level of soluble biopolymer in mixed liquor can be reduced by using the combination of polymers as described and claimed in this invention to react with and coagulate and flocculate the biopolymer forming insoluble precipitate into larger particles.

In practice, in a new MBR facility sludge production can be decreased noticeably. In some new MBR facilities, by using the method of the instant claimed invention, sludge production can be decreased by about 90%. In most new MBR facilities, by using the method of the instant claimed invention, sludge production can be decreased by at least about 50 percent. This is because the use of the combination of polymers as described and claimed herein allows for increasing HRT to about 10-15 hours without an increase in MLSS.

In the case of an existing facility where HRT is fixed, sludge production can be decreased by about 30-50 percent as use of polymers as described herein permits increasing MLSS by about 2-2.5 percent.

The water soluble anionic polymers and water soluble cationic, amphoteric or zwitterionic polymers of this invention are added to the MBR unit in line 10, to promote the coagulation of the colloidal particles, and incorporation into biofloc or to increase the porosity of the cake layer. The water soluble anionic polymers and the water soluble cationic, amphoteric or zwitterionic polymers may be solution polymers, latex polymers, dry polymers or dispersion polymers as described in United States Published Patent Application, US 2003/0159990 A1, published Aug. 28, 2003, which is incorporated by reference in its entirety. People of ordinary skill in the art of water soluble polymers are capable of synthesizing all these different types of polymers using techniques known in the art of synthetic polymer chemistry.

“Anionic monomer” means a monomer as defined herein which possesses a negative charge above a certain pH. Representative anionic monomers include acrylic acid, and its salts, including, but not limited to sodium acrylate, and ammonium acrylate, methacrylic acid, and its salts, including, but not limited to sodium methacrylate, and ammonium methacrylate, 2-acrylamido-2-methylpropanesulfonic acid (AMPS), the sodium salt of AMPS, sodium vinyl sulfonate, styrene sulfonate, maleic acid, and its salts, including, but not limited to the sodium salt, and ammonium salt, sulfonate, itaconate, sulfopropyl acrylate or methacrylate or other water-soluble forms of these or other polymerisable carboxylic or sulphonic acids. Sulfomethylated acrylamide, allyl sulfonate, sodium vinyl sulfonate, itaconic acid, acrylamidomethylbutanoic acid, fumaric acid, vinylphosphonic acid, vinylsulfonic acid, allylphosphonic acid, sulfomethylated acrylamide, phosphonomethylated acrylamide, and the like.

“Anionic polymer” means a polymer having an overall negative charge. Anionic polymers are derived from anionic monomers. Water soluble anionic polymers are soluble in water. Water soluble anionic polymers include polysaccharides such as polygalacturonic acid, polyglucuronic acid, polymannuconic acid, Alginic acid, pectins and their sodium salts, carboxymethyl cellulose, carboxymethyl starch, monophosphate starch, polylacrylic acid, polyacrylates, Poly(AMPS-Na) and poly(vinyl sulfonates).

“Cationic monomer” means a monomer which possesses a net positive charge. Representative cationic monomers include dialkylaminoalkyl acrylates and methacrylates and their quaternary or acid salts, including, but not limited to, dimethylaminoethyl acrylate methyl chloride quaternary salt, dimethylaminoethyl acrylate methyl sulfate quaternary salt, dimethyaminoethyl acrylate benzyl chloride quaternary salt, dimethylaminoethyl acrylate sulfuric acid salt, dimethylaminoethyl acrylate hydrochloric acid salt, dimethylaminoethyl methacrylate methyl chloride quaternary salt, dimethylaminoethyl methacrylate methyl sulfate quaternary salt, dimethylaminoethyl methacrylate benzyl chloride quaternary salt, dimethylaminoethyl methacrylate sulfuric acid salt, dimethylaminoethyl methacrylate hydrochloric acid salt, dialkylaminoalkylacrylamides or methacrylamides and their quaternary or acid salts such as acrylamidopropyltrimethylammonium chloride, dimethylaminopropyl acrylamide methyl sulfate quaternary salt, dimethylaminopropyl acrylamide sulfuric acid salt, dimethylaminopropyl acrylamide hydrochloric acid salt, methacrylamidopropyltrimethylammonium chloride, dimethylaminopropyl methacrylamide methyl sulfate quaternary salt, dimethylaminopropyl methacrylamide sulfuric acid salt, dimethylaminopropyl methacrylamide hydrochloric acid salt, diethylaminoethylacrylate, diethylaminoethylmethacrylate, diallyldiethylammonium chloride and diallyldimethyl ammonium chloride. Alkyl groups are generally C₁₋₄ alkyl.

“Cationic polymer” means a polymer having an overall positive charge. Water soluble cationic polymers are soluble in water. The preferred cationic polymers have a charge density of at least about 5 mol percent positive charge.

The cationic polymers of this invention include polymers composed entirely of cationic monomers and polymers composed of cationic and nonionic monomers. Cationic polymers also include condensation polymers of epichlorohydrin and a dialkyl monoamine or polyamine and condensation polymers of ethylenedichloride and ammonia or formaldehyde and an amine salt. Cationic polymers of this invention include solution polymers, emulsion polymers, dispersion polymers and structurally modified polymers as described in PCT US01/10867.

“Nonionic monomer” means a monomer which is electrically neutral. Representative nonionic monomers include acrylamide, methacrylamide, N-methylacrylamide, N,N-dimethyl(meth)acrylamide, N,N-diethyl(meth)acrylamide, N-isopropyl(meth)acrylamide, N-t-butyl(meth)acrylamide, N-(2-hydroxypropyl)methacrylamide, N-methylolacrylamide, N-vinylformamide, N-vinylacetamide, N-vinyl-N-methylacetamide, poly(ethylene glycol)(meth)acrylate, poly(ethylene glycol) monomethyl ether mono(meth)acryate, N-vinyl-2-pyrrolidone, glycerol mono((meth)acrylate), 2-hydroxyethyl(meth)acrylate, 2-hydroxypropyl(meth)acrylate, vinyl methylsulfone, vinyl acetate, glycidyl(meth)acrylate, and the like.

“Zwitterionic monomer” means a polymerizable molecule containing cationic and anionic (charged) functionality in equal proportions, so that the molecule is net neutral overall. Representative zwitterionic monomers include N,N-dimethyl-N-acryloyloxyethyl-N-(3-sulfopropyl)-ammonium betaine, N,N-dimethyl-N-acrylamidopropyl-N-(2-carboxymethyl)-ammonium betaine, N,N-dimethyl-N-acrylamidopropyl-N-(3-sulfopropyl)-ammonium betaine, N,N-dimethyl-N-methacrylamidopropyl-N-(3-sulfopropyl)-ammonium betaine (DMMAPSB), N,N-dimethyl-N-acrylamidopropyl-N-(2-carboxymethyl)-ammonium betaine, 2-(methylthio)ethyl methacryloyl-S-(sulfopropyl)-sulfonium betaine, 2-[(2-acryloylethyl)dimethylammonio]ethyl 2-methyl phosphate, 2-(acryloyloxyethyl)-2′-(trimethylammonium)ethyl phosphate, [(2-acryloylethyl)dimethylammonio]methyl phosphonic acid, 2-methacryloyloxyethyl phosphorylcholine (MPC), 2-[(3-acrylamidopropyl)dimethylammonio]ethyl 2′-isopropyl phosphate (AAPI), 1-vinyl-3-(3-sulfopropyl)imidazolium hydroxide, (2-acryloxyethyl) carboxymethyl methylsulfonium chloride, 1-(3-sulfopropyl)-2-vinylpyridinium betaine, N-(4-sulfobutyl)-N-methyl-N,N-diallylamine ammonium betaine (MDABS), N,N-diallyl-N-methyl-N-(2-sulfoethyl) ammonium betaine, and the like. A preferred zwitterionic monomer is N,N-dimethyl-N-methacrylamidopropyl-N-(3-sulfopropyl)-ammonium betaine.

“Zwitterionic polymer” means a polymer composed from zwitterionic monomers and, possibly, other non-ionic monomer(s). Water soluble zwitterionic polymers have been found to be soluble in water. Representative zwitterionic polymers include homopolymers such as the homopolymer of N,N-dimethyl-N-(2-acryloyloxyethyl)-N-(3-sulfopropyl) ammonium betaine, copolymers such as the copolymer of acrylamide and N,N-dimethyl-N-(2-acryloyloxyethyl)-N-(3-sulfopropyl) ammonium betaine, and terpolymers such as the terpolymer of acrylamide, N-vinyl-2-pyrrolidone, and 1-(3-sulfopropyl)-2-vinylpyridinium betaine. In zwitterionic polymers, all the polymer chains and segments within those chains are rigorously electrically neutral. Therefore, zwitterionic polymers represent a subset of amphoteric polymers, necessarily maintaining charge neutrality across all polymer chains and segments because both anionic charge and cationic charge are introduced within the same zwitterionic monomer.

“Amphoteric polymer” means a polymer derived from both cationic monomers and anionic monomers, and, possibly, other non-ionic monomer(s). Amphoteric polymers can have a net positive or negative charge. Water soluble amphoteric polymers are soluble in water. Representative amphoteric polymers include acrylic acid/DMAEA.MCQ copolymer, DADMAC/acrylic acid copolymer, DADMAC/acrylic acid/acrylamide terpolymer, and the like.

The amphoteric polymer may also be derived from zwitterionic monomers and cationic or anionic monomers and possibly nonionic monomers. Representative amphoteric polymers containing zwitterionic monomers include DMAEA.MCQ/N,N-dimethyl-N-methacrylamidopropyl-N-(3-sulfopropyl)-ammonium betaine copolymer, acrylic acid/N,N-dimethyl-N-methacrylamidopropyl-N-(3-sulfopropyl)-ammonium betaine copolymer, DMAEA.MCQ/Acrylic acid/N,N-dimethyl-N-methacrylamidopropyl-N-(3-sulfopropyl)-ammonium betaine terpolymer, and the like.

In a preferred aspect of this invention, the water soluble anionic polymers have a molecular weight from about 2000 dalton to about 10,000,000 dalton.

In another preferred aspect, the water soluble anionic polymer is a polygalacturonic acid (PGA) because it is one of the anionic polysaccharides found in extra-cellular polysaccharides.

In another preferred aspect, the anionic polymer has an anionic charge of at least about 5 mole percent.

In another preferred aspect, the water soluble anionic polymer is selected from the group consisting of polyacrylates.

In a preferred aspect of this invention, the water soluble cationic, amphoteric or zwitterionic polymers have a molecular weight from about 2000 dalton to about 10,000,000 dalton.

During addition of anionic polymer, membrane flux should be reduced to lower than operating flux and/or sub-critical flux, to allow for good mixing of the polymer with the sludge.

When the water soluble anionic polymer is added prior to the addition of the water-soluble cationic polymer or amphoteric polymer or zwitterionic polymer the water-soluble cationic polymer or amphoteric polymer or zwitterionic polymer should be added and allowed to mix well for about 30 minutes before increasing the flux to the pre-determined value. The TMP should be monitored with time.

When the water soluble anionic polymer is added simultaneously with the addition of the water-soluble cationic polymer or amphoteric polymer or zwitterionic polymer the polymers should be added and allowed to mix well with the mixed liquor for about 30 minutes before increasing flux to the pre-determined value. The TMP should be monitored with time.

When the water soluble anionic polymer is added after the addition of the water-soluble cationic polymer or amphoteric polymer or zwitterionic polymer the water-soluble cationic polymer or amphoteric polymer or zwitterionic polymer should be added and then the water soluble anionic polymer should be added and allowed to mix well with the mixed liquor for about 30 minutes before increasing the flux to the pre-determined value. The TMP should be monitored with time.

In a preferred aspect, the cationic polymer is a copolymer of acrylamide and one or more cationic monomers selected from diallyldimethylammonium chloride, dimethylaminoethylacrylate methyl chloride quaternary salt, dimethylaminoethylmethacrylate methyl chloride quaternary salt and dimethylaminoethylacrylate benzyl chloride quaternary salt.

In another preferred aspect, the cationic polymer has a cationic charge of at least about 5 mole percent.

In another preferred aspect, the cationic polymer has a cationic charge of 100 mole percent.

In another preferred aspect, the cationic polymer has a molecular weight from about 2,000,000 dalton to about 5,000,000 dalton.

In another preferred aspect, the cationic polymer is selected from the group consisting of polydiallyldimethylammonium chloride, polyethyleneimine, polyepiamine, polyepiamine crosslinked with ammonia or ethylenediamine, condensation polymer of ethylenedichloride and ammonia, condensation polymer of triethanolamine and tall oil fatty acid, poly(dimethylaminoethylmethacrylate sulfuric acid salt) and poly(dimethylaminoethylacrylate methyl chloride quaternary salt). In a preferred aspect, the amphoteric polymer is selected from dimethylaminoethyl acrylate methyl chloride quaternary salt/acrylic acid copolymer, diallyldimethylammonium chloride/acrylic acid copolymer, dimethylaminoethyl acrylate methyl chloride salt/N,N-dimethyl-N-methacrylamidopropyl-N-(3-sulfopropyl)-ammonium betaine copolymer, acrylic acid/N,N-dimethyl-N-methacrylamidopropyl-N-(3-sulfopropyl)-ammonium betaine copolymer and DMAEA.MCQ/Acrylic acid/N,N-dimethyl-N-methacrylamidopropyl-N-(3-sulfopropyl)-ammonium betaine terpolymer. The more preferred cationic polymer is diallyldimethylammonium chloride/acrylamide copolymer.

In another preferred aspect, the amphoteric polymer has a molecular weight from about 5,000 dalton to about 2,000,000 dalton. In a more preferred aspect, the amphoteric polymer has a molecular weight from about 1,000,000 dalton to about 2,000,000 dalton.

In another preferred aspect, the amphoteric polymer has a cationic charge equivalent to anionic charge equivalent ratio of about 0.2:9.8 to about 9.8:0.2.

In another preferred aspect the amphoteric polymer is a 70/30 blend of DMAEA.MCQ and acrylic acid. This is a preferred amphoteric polymer because it consistently exhibits good flux enhancement.

In another preferred aspect, the water soluble zwitterionic polymer is composed of about 1 to about 99 mole percent of N,N-dimethyl-N-methacrylamidopropyl-N-(3-sulfopropyl)-ammonium betaine and about 99 to about 1 mole percent of one or more nonionic monomers.

In another preferred aspect, the water soluble zwitterionic polymer has a molecular weight from about 5,000 dalton to about 2,000,000 dalton. In a more preferred aspect, the nonionic polymer has a molecular weight from about 1,000,000 dalton to about 2,000,000 dalton.

In another preferred aspect, the nonionic monomer is acrylamide.

In another preferred aspect, the nonionic polymer has a molecular weight from about 5,000 dalton to about 2,000,000 dalton. In a more preferred aspect, the nonionic polymer has a molecular weight from about 1,000,000 dalton to about 2,000,000 dalton.

The recommended polymer dosage, for any of the polymers added, based on mixed liquor in the bioreactor, is from about 1 to about 2000 ppm on active basis, at MLSS (mixed liquor suspended solids) of approximately 1-2%. The preferred polymer dosage, for any of the polymers added, based on mixed liquor in the bioreactor, is from about 1 to about 200 ppm on active basis, at MLSS of approximately 1-2%. The more preferred polymer dosage, for any of the polymers added, based on mixed liquor in the bioreactor, is from about 10 to about 100 ppm on active basis, at MLSS of approximately 1-2%.

If the MLSS is lower than 1%, a proportionately lower dosage of polymer may be used.

The polymer can be periodically pumped directly to the bioreactor mixed liquor through line 10 or it may enter the bioreactor through sludge disintegrator return line 8. The polymer may be pumped intermittently (“slug fed”) or continuously to the bioreactor mixed liquor. If polymer is fed continuously then the amount of polymer being fed can be proportionally less than if the polymer is slug fed, to achieve the same desired concentration of polymer in the mixed liquor.

The amount of polymer chosen to be added, will be the amount at which the floc size is optimal and where turbidity and viscosity are lower than with no polymer present.

In all cases, the polymer should be thoroughly mixed with the mixed liquor in the bioreactor to maximize adsorption. This may be accomplished by feeding the polymer into an area of the bioreactor where an aeration nozzle is located. So-called “dead” zones in the bioreactor having little or no flow should be avoided. In some cases, a submerged propeller mixer may be needed to increase mixing in the basin, or the sludge can be re-circulated through a side arm loop.

Overdosing polymer is not recommended. Overdosing polymer may result in reduced biological activity and organics removal in the bioreactor. For this reason, a low polymer level should be tried initially: for example about 1 to about 25 ppm on active basis in the mixed liquor. Additional polymer can then be fed to increase flux while maintaining biological activity. Permeate TOC (total organic carbon), COD (chemical oxygen demand), or BOD (biological oxygen demand) can be monitored to ascertain biological activity.

The water soluble anionic polymer may be added either before the water soluble cationic, amphoteric and zwitterionic polymers are added or the water soluble anionic polymer may be added after the water soluble cationic, amphoteric and zwitterionic polymers are added or the water soluble anionic polymer may be added simultaneously with the water soluble cationic, amphoteric and zwitterionic polymers.

In conducting the method of the instant claimed invention it is preferred to add the one or more water soluble anionic polymers either prior to or after the addition of the one or more water soluble cationic, amphoteric and zwitterionic polymers. In conducting the method of the instant claimed invention it is more preferred to add the one or more water soluble anionic polymers prior to the addition of the one or more water soluble cationic, amphoteric and zwitterionic polymers.

In conducting the method of the instant claimed invention and adding the combination of polymers described herein, into the bioreactor, it is first recommended, although not required, that ajar test be conducted with samples of mixed liquor from the MBR. The jar test uses sample jars of mixed liquor that are dosed with different combinations of different water soluble polymers, in different sequential order, with one jar being left untreated. After mixing, the samples are allowed to sit for several hours, so that the solids can settle to the bottom of the jar. The turbidity of the water on top of the settled solids (supernatant) is measured to ascertain the effectiveness of the combination of polymers tried. Any commercially available turbidimeter device, such as a turbidimeter from Hach Company of Loveland, Colo. could be used to measure turbidity. It has been found that with this type of testing, when a specific combination of water soluble polymers yields lower turbidity in the jar as compared to the sample jar that has been untreated, that the same combination of water soluble polymers, added in the same order as they were added during the jar test, will be expected to increase flux in the MBR.

In the event of an accidentally high polymer overdose, (greater than about 4000 ppm on active basis) dosing of polymer should be halted until biological activity returns to normal levels. It may also be necessary to discharge more sludge from the bioreactor to assist in recovery of bioactivity. Addition of bioaugmentation products containing appropriate bacteria may also be helpful in recovering activity after polymer overdose.

When using the method of the instant claimed invention it has been found to be possible to condition the mixed liquor in a membrane biological reactor.

When using the method of the instant claimed invention it has been found to be possible to clarify wastewater in a membrane biological reactor where microorganisms consume organic material in the wastewater to form a mixed liquor comprising water, the microorganisms and dissolved and suspended solids.

When using the method of the instant claimed invention it has been found to be possible to prevent fouling of a filtration membrane in a membrane biological reactor where microorganisms consume organic material in the wastewater in a mixed liquor comprising water, the microorganisms and dissolved, colloidal and suspended solids and wherein clarified water is separated from the mixed liquor by filtration through the filtration membrane.

When using the method of the instant claimed invention it has been found to be possible to enhance the flux through a filtration membrane in a membrane biological reactor where microorganisms consume organic material in the wastewater in a mixed liquor comprising water, the microorganisms and dissolved, colloidal and suspended solids and wherein clarified water is separated from the mixed liquor by filtration through the filtration membrane.

When using the method of the instant claimed invention it has been found to be possible to reduce sludge formation in a membrane biological reactor where microorganisms consume organic material in the wastewater to form a mixed liquor comprising water, the microorganisms and a sludge comprising dissolved, colloidal and suspended solids and wherein clarified water is separated from the mixed liquor by filtration through a membrane and wherein the concentration of microorganisms in the mixed liquor is increased.

When using the method of the instant claimed invention it has been found to be possible to reduce sludge formation in a membrane biological reactor where microorganisms consume organic material in the wastewater to form a mixed liquor comprising water, the microorganisms and a sludge comprising dissolved, colloidal and suspended solids; wherein the desired clarified water is separated from the mixed liquor by filtration through a membrane; and wherein the amount of time that the microorganisms remain in contact with the wastewater is increased.

Although this invention has been described in detail for the purpose of illustration, it is to be understood that such detail is solely for that purpose and that numerous modifications, alterations and changes can be made therein by those skilled in the art without departing from the spirit and scope of the invention except as it may be limited by the claims. All changes which come within the meaning and range of equivalency of the claims are to be embraced within their scope.

What is claimed is:

1. A method of conditioning mixed liquor in a membrane biological reactor comprising:
adding one or more water soluble anionic polymers to the mixed liquor; and
adding one or more water soluble cationic, amphoteric or zwitterionic polymers, or a combination thereof to the mixed liquor;
wherein said one or more water soluble anionic polymers may be added either before, simultaneously or after the addition of said water soluble cationic, amphoteric or zwitterionic polymers.

2. The method of claim 1 in which the water soluble anionic polymers are selected from the group comprising polysaccharides such as polygalacturonic acid, polyglucuronic acid, polymannuconic acid, Alginic acid, pectins and their sodium salts, carboxymethyl cellulose, carboxymethyl starch, monophosphate starch, polylacrylic acid, polyacrylates, Poly(AMPS-Na) and poly(vinyl sulfonates).

3. The method of claim 1 in which the anionic polymer has an anionic charge of at least about 5 mole percent.

4. A method of clarifying wastewater in a membrane biological reactor where microorganisms consume organic material in the wastewater to form a mixed liquor comprising water, the microorganisms and dissolved and suspended solids comprising:
adding one or more water soluble anionic polymers to the mixed liquor;
adding one or more water soluble cationic, amphoteric or zwitterionic polymers, or a combination thereof to the mixed liquor to form a mixture comprising water, the microorganisms and coagulated and flocculated solids; and
separating clarified water from the microorganisms and the coagulated and flocculated solids by filtration through a membrane; wherein said one or more water soluble anionic polymers may be added either before, simultaneously or after the addition of said water soluble cationic, amphoteric or zwitterionic polymers.

5. The method of claim 4 in which the water soluble anionic polymers are selected from the group comprising polysaccharides such as polygalacturonic acid, polyglucuronic acid, polymannuconic acid, Alginic acid, pectins and their sodium salts, carboxymethyl cellulose, carboxymethyl starch, monophosphate starch, polylacrylic acid, polyacrylates, Poly(AMPS-Na) and poly(vinyl sulfonates).

6. The method of claim 4 in which the anionic polymer has an anionic charge of at least about 5 mole percent.

7. A method of preventing fouling of a filtration membrane in a membrane biological reactor where microorganisms consume organic material in the wastewater in a mixed liquor comprising water, the microorganisms and dissolved, colloidal and suspended solids and wherein clarified water is separated from the mixed liquor by filtration through the filtration membrane comprising
adding one or more water soluble anionic polymers to the mixed liquor; and
adding to the mixed liquor an amount of one or more cationic, amphoteric or zwitterionic polymers, or a combination thereof, sufficient to prevent fouling of the membrane; wherein said one or more water soluble anionic polymers may be added either before, simultaneously or after the addition of said water soluble cationic, amphoteric or zwitterionic polymers.

8. The method of claim 7 in which the water soluble anionic polymers are selected from the group comprising polysaccharides such as polygalacturonic acid, polyglucuronic acid, polymannuconic acid, Alginic acid, pectins and their sodium salts, carboxymethyl cellulose, carboxymethyl starch, monophosphate starch, polylacrylic acid, polyacrylates, Poly(AMPS-Na) and poly(vinyl sulfonates).

9. The method of claim 7 in which the anionic polymer has an anionic charge of at least about 5 mole percent.

10. A method of enhancing flux through a filtration membrane in a membrane biological reactor where microorganisms consume organic material in the wastewater in a mixed liquor comprising water, the microorganisms and dissolved, colloidal and suspended solids and wherein clarified water is separated from the mixed liquor by filtration through the filtration membrane comprising
adding one or more water soluble anionic polymers to the mixed liquor; and
adding to the mixed liquor an effective flux enhancing amount of one or more cationic, amphoteric or zwitterionic polymers, or a combination thereof; wherein said one or more water soluble anionic polymers may be added either before, simultaneously or after the addition of said water soluble cationic, amphoteric or zwitterionic polymers.

11. The method of claim 10 in which the water soluble anionic polymers are selected from the group comprising polysaccharides such as polygalacturonic acid, polyglucuronic acid, polymannuconic acid, Alginic acid, pectins and their sodium salts, carboxymethyl cellulose, carboxymethyl starch, monophosphate starch, polylacrylic acid, polyacrylates, Poly(AMPS-Na) and poly(vinyl sulfonates).

12. The method of claim 10 in which the anionic polymer has an anionic charge of at least about 5 mole percent.

13. A method of reducing sludge formation in a membrane biological reactor where microorganisms consume organic material in the wastewater to form a mixed liquor comprising water, the microorganisms and a sludge comprising dissolved, colloidal and suspended solids and wherein clarified water is separated from the mixed liquor by filtration through a membrane comprising
adding one or more water soluble anionic polymers to the mixed liquor;
adding to the mixed liquor an effective coagulating and flocculating amount of one or more cationic, amphoteric or zwitterionic polymers, or a combination thereof; and
increasing the concentration of microorganisms in the mixed liquor; wherein said one or more water soluble anionic polymers may be added either before, simultaneously or after the addition of said water soluble cationic, amphoteric or zwitterionic polymers.

14. The method of claim 13 in which the water soluble anionic polymers are selected from the group comprising polysaccharides such as polygalacturonic acid, polyglucuronic acid, polymannuconic acid, Alginic acid, pectins and their sodium salts, carboxymethyl cellulose, carboxymethyl starch, monophosphate starch, polylacrylic acid, polyacrylates, Poly(AMPS-Na) and poly(vinyl sulfonates).

15. The method of claim 13 in which the anionic polymer has an anionic charge of at least about 5 mole percent.

16. A method of reducing sludge formation in a membrane biological reactor where microorganisms consume organic material in the wastewater to form a mixed liquor comprising water, the microorganisms and a sludge comprising dissolved, colloidal and suspended solids and wherein clarified water is separated from the mixed liquor by filtration through a membrane comprising
adding one or more water soluble anionic polymers to the mixed liquor;
adding to the mixed liquor an effective coagulating and flocculating amount of one or more cationic, amphoteric or zwitterionic polymers, or a combination thereof; and
increasing the amount of time that the microorganisms remain in contact with the wastewater;
wherein said one or more water soluble anionic polymers may be added either before, simultaneously or after the addition of said water soluble cationic, amphoteric or zwitterionic polymers.

17. The method of claim 16 in which the water soluble anionic polymers are selected from the group comprising polysaccharides such as polygalacturonic acid, polyglucuronic acid, polymannuconic acid, Alginic acid, pectins and their sodium salts, carboxymethyl cellulose, carboxymethyl starch, monophosphate starch, polylacrylic acid, polyacrylates, Poly(AMPS-Na) and poly(vinyl sulfonates).

18. The method of claim 16 in which the anionic polymer has an anionic charge of at least about 5 mole percent.
